(19) United States
(12) Patent Application Publication
(10) Pub. No.: US 2022/0017339 A1
(43) Pub. Date: Jan. 20, 2022

(54) Intelligent Hydraulic Jack System

(71) Applicant: Joshua Calloway, Fargo, ND (US)

(72) Inventor: Joshua Calloway, Fargo, ND (US)

(21) Appl. No.: 16/932,702

(22) Filed: Jul. 17, 2020

(51) Int. Cl. B66F 3/46; B66F 3/26; B60S 9/12

(52) U.S. Cl. CPC B66F 3/46; B66F 2700/05; B60S 9/12; B66F 3/26

(57) ABSTRACT

The independent hydraulic jack system uses four independent jacks strategically mounted on the four corners of the bottom of a vehicle. Each of the jacks is connected via hydraulic hoses to a central hydraulic pump, also mountable on the bottom of the vehicle. The hydraulic pump can raise or lower any of the four jacks without affecting the other three. This hydraulic pump is controlled by a user-operated remote control whereby the user can directly adjust the height of the four jacks. The control also has a locking feature whereby the jacks will not alter their height until the control is unlocked. As a safety precaution, the pump cannot be utilized unless the vehicle brakes are applied.

### BACKGROUND

The most common form is a car jack, floor jack or garage jack, which lifts vehicles so that maintenance can be performed. Jacks are usually rated for a maximum lifting capacity. Hydraulic jacks are typically used for shop work, rather than as an emergency jack to be carried with the vehicle. Use of jacks not designed for a specific vehicle requires more than the usual care in selecting ground conditions, the jacking point on a vehicle, and to ensure stability when the jack is extended. There have been no products available as original equipment or as an aftermarket to address this problem.

National and international standards have been developed to standardize the safety and performance requirements for jacks and other lifting devices. Selection of the standard is an agreement between the purchaser and the manufacturer, and has some significance in the design of the jack. There have been no products available as original equipment or as an aftermarket to address this problem either.

There exists a need for a mounted hydraulic jack system that is not being met by any known or disclosed device or system of present.

### SUMMARY OF THE INVENTION

The intelligent hydraulic jack system uses four independent jacks strategically mounted on the four corners of the bottom of a vehicle. Each of the jacks is connected via hydraulic hoses to a central hydraulic pump, also mounted on the bottom of the vehicle. The hydraulic pump can raise or lower any of the four jacks without affecting the other three. This hydraulic pump is controlled by a user-operated remote control whereby the user can directly adjust the height of the four jacks. The control also has a locking feature whereby the jacks will not alter their height until the control is unlocked. As a safety precaution, the pump cannot be utilized unless the vehicle brakes are applied.

### BRIEF DESCRIPTION OF THE DRAWINGS

FIG. 1 is a view of the independent hydraulic jack system from above the vehicle in accordance with an embodiment of the present disclosure.

FIG. 2 is a side perspective view of a single hydraulic jack in accordance with an embodiment of the present disclosure.

FIG. 3 is an upper view of the jack-controlling remote control in accordance with an embodiment of the present disclosure.

FIG. 4 is a block diagram of a method of jacking a vehicle via four independent hydraulic jacks in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present disclosure the term ‘central’ is used to refer to a hydraulic pump which is both physically central to the hydraulic jacks and also hydraulically central to the hydraulic jacks. The term wirelessly refers to devices, apparatuses and methods of operation and control via electromagnetic waves in the full spectrum of visible, invisible, short wave, long wave and other lengths known to a person of ordinary skill in the art. The term ‘intelligent,’ refers to an ability to control and operate the disclosure via circuits, electronic memory, software applications and methods as disclosed herein.

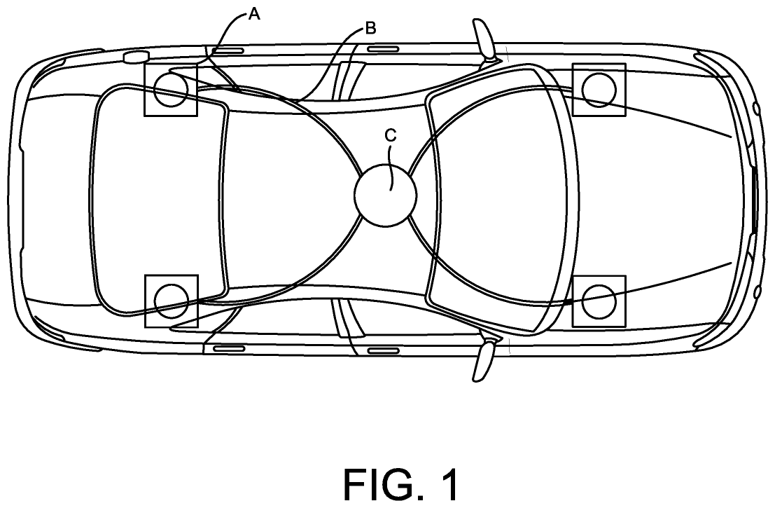

FIG. 1 is a view of the jack system from above the vehicle in accordance with an embodiment of the present disclosure. The vehicle to which the system is attached appears transparent to make seeing the jack system on the vehicle's underbelly possible from above in accordance with an embodiment of the present disclosure. Each of the four jacks A is stationed at a different corner of the vehicle. Each jack operates independently of the others, but is connected to a central control unit C which is a hydraulic pump. There is a hydraulic hose connection B which runs from the central hydraulic pump to each of the four jacks.

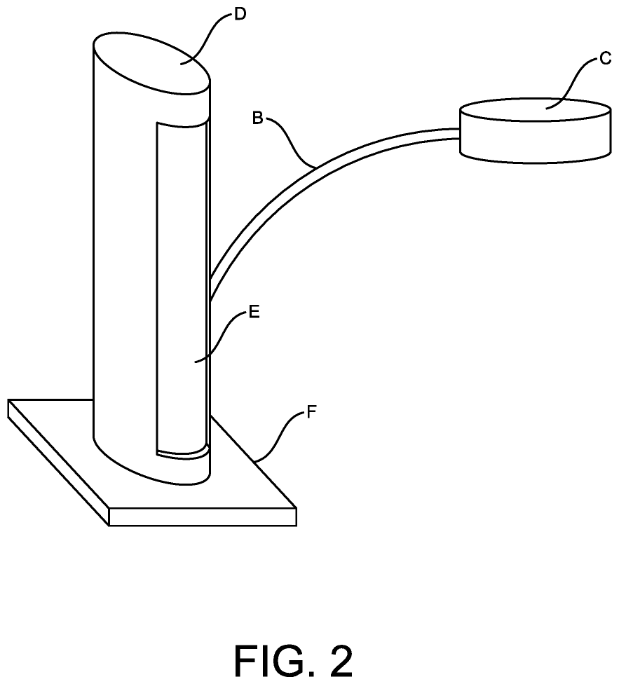

FIG. 2 is a side perspective view of a single independent hydraulic jack in accordance with an embodiment of the present disclosure. The figure depicts the attachment of the jack to the bottom of the vehicle D and the hydraulic extensible section E, which only deploys when the button is pressed and the vehicle brakes are applied. On the extensible section, on the side opposite to the attachment to the vehicle is the jack's foot F that measures 4×4×½ inches.

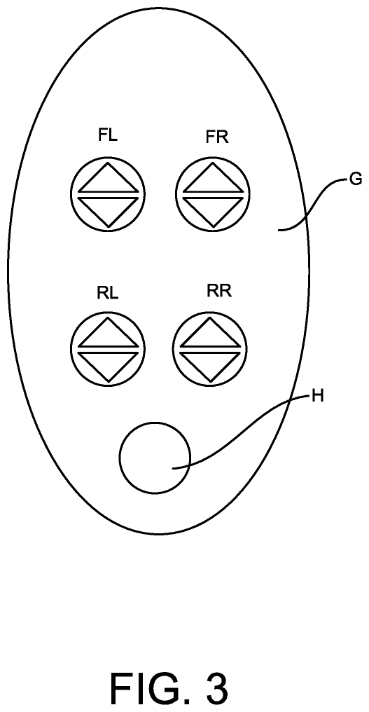

FIG. 3 is an upper view of the jack-controlling remote in accordance with an embodiment of the present disclosure. Detailed in the figure are the five distinct controls of how the jack system operates, specifically how each of the four jacks may change their position independent of the other three in accordance with an embodiment of the present disclosure. On the face of the remote G there is an up and a down control for each of the four jacks. Additionally, there is a button H to lock the jacks in place. The remote controls the use of the central hydraulic pump.

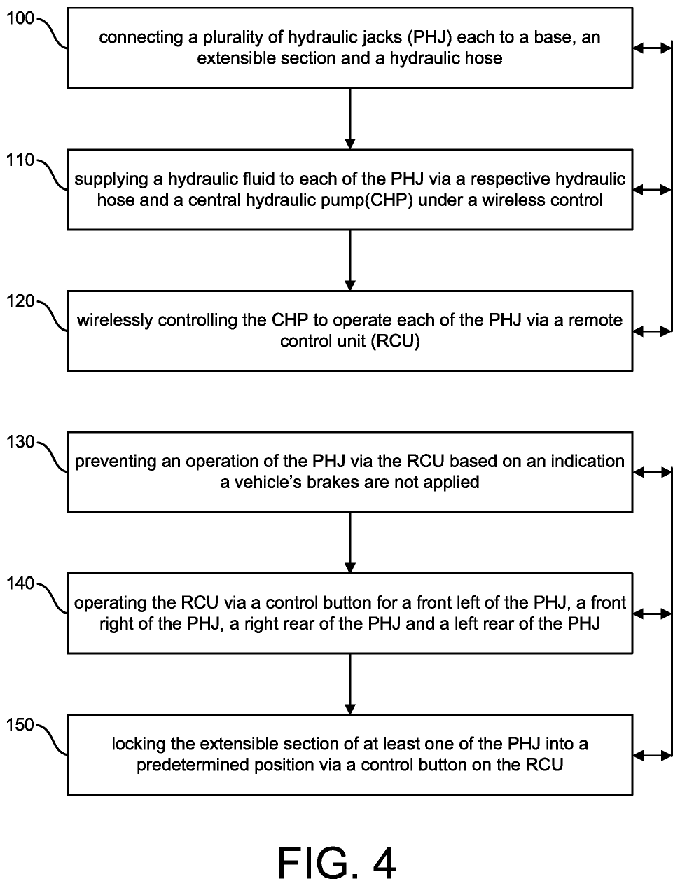

FIG. 4 is a block diagram of a method of jacking a vehicle via four independent hydraulic jacks in accordance with an embodiment of the present disclosure. The method comprises connecting 100 a plurality of hydraulic jacks (PHJ) each to a base, an extensible section and a hydraulic hose. The method also comprises supplying 110 a hydraulic fluid to each of the PHJ via a respective hydraulic hose and a central hydraulic pump (CHP) under a wireless control. The method additionally comprises wirelessly controlling 120 the CHP to operate each of the PHJ via a remote control unit (RCU).

Embodiments of the method comprise preventing 130 an operation of the PHJ via the RCU based on an indication a vehicle's brakes are not applied. Embodiments of the method also comprise operating 140 the RCU via a control button for a front left of the PHJ, a front right of the PHJ, a right rear of the PHJ and a left rear of the PHJ. Embodiments of the method additionally comprise locking 150 the extensible section of at least one of the PHJ into a predetermined position via a control button on the RCU. Embodiments of the method further comprise wirelessly controlling each of the PHJ simultaneously in parallel via the RCU. Embodiments of the method yet comprise wirelessly controlling each of the PHJ consecutively in series via the RCU according to a preset sequence.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

While the forgoing examples are illustrative of the principles of the present disclosure in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the disclosure be limited, except as by the specification and claims set forth herein.

What is claimed is:

1. A hydraulic jack system comprising:
a plurality of hydraulic jacks (PHJ) each comprising a base, an extensible section and a hydraulic hose;
a central hydraulic pump (CHP) configured to supply a hydraulic fluid to each of the PHJ via a respective hydraulic hose via a wireless control; and
a remote control unit (RCU) configured to wirelessly control the CHP and therefore operate each of the PHJ.

2. The hydraulic jack system of claim 1, wherein the RCU further comprises a control button for a front left of the PHJ, a front right of the PHJ, a right rear of the PHJ and a left rear of the PHJ.

3. The hydraulic jack system of claim 1, wherein the CHP further comprises a hydraulic control valve for each of a front left of the PHJ, a front right of the PHJ, a right rear of the PHJ and a left rear of the PHJ.

4. The hydraulic jack system of claim 1, further comprising a lock button on the RCU configured to lock the extensible section of at least one of the PHJ into a predetermined position.

5. The hydraulic jack system of claim 1, wherein the RCU is configured to wirelessly control each of the PHJ simultaneously in parallel.

6. The hydraulic jack system of claim 1, wherein the RCU is configured to wirelessly control each of the PHJ consecutively in series.

7. The hydraulic jack system of claim 1, wherein the RCU is configured to wirelessly control each of the PHJ according to a preset sequence.

8. The hydraulic jack system of claim 1, further comprising a PHJ for a front left of a vehicle, a PHJ for a front right of the vehicle, a PHJ for a rear left of the vehicle and a PHJ for a rear right of the vehicle.

9. The hydraulic jack system of claim 1, further comprising a logic circuit which controls an operation of the system via the RCU based on an indication a vehicle's brakes are applied.

10. The hydraulic jack system of claim 1, wherein the RCU is a cell phone.

11. A method for jacking a vehicle, the method comprising:
connecting a plurality of hydraulic jacks (PHJ) each to a base, an extensible section and a hydraulic hose;
supplying a hydraulic fluid to each of the PHJ via a respective hydraulic hose and a central hydraulic pump (CHP) under a wireless control; and
wirelessly controlling the CHP to operate each of the PHJ via a remote control unit (RCU).

12. The method of claim 11, further comprising operating the RCU via a control button for a front left of the PHJ, a front right of the PHJ, a right rear of the PHJ and a left rear of the PHJ.

13. The method of claim 11, further comprising preventing an operation of the PHJ via the RCU based on an indication a vehicle's brakes are not applied.

14. The method of claim 11, further comprising locking the extensible section of at least one of the PHJ into a predetermined position via a control button on the RCU.

15. The method of claim 11, further comprising wirelessly controlling each of the PHJ simultaneously in parallel via the RCU.

16. The method of claim 11, further comprising wirelessly controlling each of the PHJ consecutively in series via the RCU.

17. The method of claim 11, further comprising wherein the RCU is configured to wirelessly control each of the PHJ according to a preset sequence.

18. A hydraulic jack system for a vehicle, the system comprising:
at least four hydraulic jacks (HJ) each comprising a base, an extensible section and a hydraulic hose of equal length;
a central hydraulic pump (CHP) configured to supply a hydraulic fluid to each of the at least four HJ via a respective hydraulic hose via a wireless control; and
a remote control unit (RCU) configured to wirelessly control the CHP and therefore operate each of the at least four HJ.

19. The system of claim 18, further comprising a logic circuit which controls an operation of the system via the RCU based on an indication the vehicle's brakes are applied.

20. The system of claim 18, further comprising a single hydraulic jack, a single hydraulic pump and a single remote control unit.
